(19) United States
(12) Patent Application Publication
(10) Pub. No.: US 2017/0272378 A1
(43) Pub. Date: Sep. 21, 2017

(54) Network Communication Apparatus and Electronic Apparatus

(71) Applicant: Realtek Semiconductor Corp., HsinChu (TW)

(72) Inventors: Zhen-Ting Huang, Yunlin County (TW); Chun-Hao Lin, New Taipei City (TW); Chung-Keng Hung, Taichung City (TW); Chia-Ying Chiu, Hsinchu County (TW)

(21) Appl. No.: 15/203,813

(22) Filed: Jul. 7, 2016

(30) Foreign Application Priority Data
Mar. 16, 2016 (TW) 105108067

(51) Int. Cl. H04L 12/911; H04L 12/721

(52) U.S. Cl. CPC H04L 47/70; H04L 45/72

(57) ABSTRACT

A network communication apparatus includes a transmission interface and a network interface controller. The transmission interface is coupled to an electronic apparatus, in which the electronic apparatus includes a non-volatile memory for storing a unique medium access control (MAC) address that is authorized by a network. The network interface controller is coupled to the transmission interface and includes a storage device. If the electronic apparatus is coupled to the transmission interface, the electronic apparatus transmits the unique MAC address to the storage device, such that the network interface controller utilizes the unique MAC address to connect to the network, and the electronic apparatus is capable of accessing the network.

### BACKGROUND OF THE INVENTION

1. Field of the Invention

The disclosure relates to a network communication apparatus and an electronic apparatus, and more particularly, to a network communication apparatus and an electronic apparatus which can adaptively manage a network access authorization.

2. Description of the Prior Art

Conventionally, various portable devices and electronic computing apparatuses are installed with unique medium access control (MAC) addresses while being produced, such that network managers of relevant institutions or companies can dispose a number of routers in the local area network (LAN) to identify those MAC addresses utilized by the various portable devices and electronic computing apparatuses and to distribute unique Internet protocol (IP) addresses, respectively, so as to allow users of the portable devices and the electronic computing apparatuses to surf the Internet and access the network information/data. In the meanwhile, the network managers can adaptively monitor the unique IP addresses of the portable devices and the electronic computing apparatuses, to adaptively permit or prohibit the portable devices and the electronic computing apparatuses to access the LAN. Alternatively, the network managers can install applications inside the portable devices and the electronic computing apparatuses to correspondingly designate programmed addresses, such that any one of the portable devices and the electronic computing apparatuses can have the permission to access the LAN via the assigned programmed address.

However, while the wireless/wired dongle systems and wireless/wired docking stations of ultra-thin laptops are rapidly developed, any user can connect his/her portable device or electronic computing apparatus to the wireless/wired docking stations so as to access the LAN via an authorized MAC address of a network interface controller inside the wireless/wired docking stations. Accordingly, it seems difficult to manage the network access authorization for the network managers. Further, if the programmed addresses are utilized by the network managers of the institutions or companies, more costs and installation processes may be necessary. On the other hand, for those malevolent experts, they should be capable of cracking the applications to arbitrarily rewrite the predetermined MAC address, which may result in a potential security concerns, and the network managers are impossible to severely monitor the network access authorization of the LAN.

Therefore, it has become an important issue to provide a network communication apparatus and an electronic apparatus which can adaptively manage a network access authorization with the rapid development of the wired/wireless docking stations or dongle systems.

### SUMMARY OF THE INVENTION

Therefore, the primary objective of the disclosure is to provide a network communication apparatus and an electronic apparatus which can adaptively manage a network access authorization.

The disclosure provides a network communication apparatus. The network communication apparatus includes a transmission interface and a network interface controller. The transmission interface is coupled to an electronic apparatus, in which the electronic apparatus includes a non-volatile memory for storing a unique medium access control (MAC) address that is authorized by a network. The network interface controller is coupled to the transmission interface and includes a storage device. If the electronic apparatus is coupled to the transmission interface, the electronic apparatus transmits the unique MAC address to the storage device, such that the network interface controller utilizes the unique MAC address to connect to the network, and the electronic apparatus is capable of accessing the network.

The disclosure further provides an electronic apparatus. The electronic apparatus is coupled to a network communication apparatus for accessing a network. The network communication apparatus includes a transmission interface and a network interface controller. The electronic apparatus includes a non-volatile memory and a connecting module. The non-volatile memory is configured to store a unique medium access control (MAC) address that is authorized by a network. The connecting module is configured to connect to the transmission interface. If the electronic apparatus is coupled to the transmission interface, the electronic apparatus transmits the unique MAC address to a storage device of the network interface controller, such that the electronic apparatus utilizes the network interface controller to connect to the network.

These and other objectives of the disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a network communication device coupled to an electronic apparatus according to an embodiment of the disclosure.

FIG. 2 illustrates a schematic diagram of another network communication device coupled to an electronic apparatus according to an embodiment of the disclosure.

FIG. 3 illustrates a flowchart of a control process according to an embodiment of the disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in sub-module. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

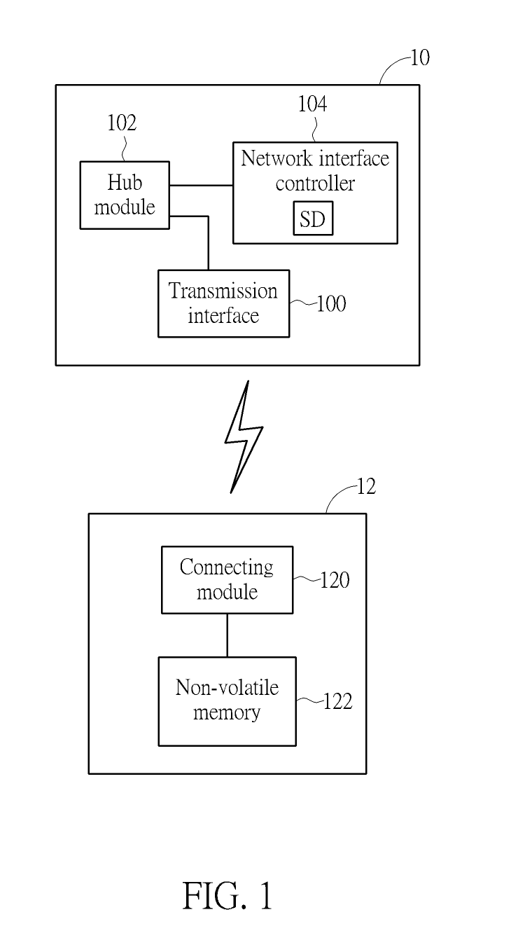

Reference is made to FIG. 1, and FIG. 1 illustrates a schematic diagram of a network communication device 10 coupled to an electronic apparatus 12 according to an embodiment of the disclosure. As shown in FIG. 1, the network communication device 10 of the present embodiment comprises a transmission interface 100, a hub module 102 and a network interface controller 104. The interface controller 104 further comprises a storage device SD. In detail, the transmission interface 100 is coupled to the electronic apparatus 12, the hub module 102 is electrically connected to the transmission interface 100 and the network interface controller 104, and the storage device SD initially stores a predetermined medium access control (MAC) address to make the network communication apparatus 10 obtain an Internet protocol (IP) address. Certainly, the number of the hub module 102 of the network communication apparatus 10 is illustrated herein for demonstration. In other embodiments, the network communication apparatus 10 may not comprise the hub module 102, and accordingly, the transmission interface 100 is coupled to the network interface controller 104. In other words, data received by the transmission interface 100 may be directly transmitted to the network interface controller 104.

In other embodiments, the storage device SD may be at least one register.

In addition, the electronic apparatus 12 of the embodiment may be a mobile apparatus, a laptop, a computer system, a wearable apparatus or any electronic apparatus having computing function. For detailed illustration, the electronic apparatus 12 shown in FIG. 1 only depicts the main components comprising a connecting module 120 and a non-volatile memory 122. The connecting module 120 is configured to connect to the transmission interface 100 of the network communication apparatus 10, and the non-volatile memory 122 is configured to store a unique MAC address which is authorized by a network (or a LAN). In other words, if the electronic apparatus 12 connects to the network (or the LAN), the authorized unique MAC address may be utilized such that an Internet protocol (IP) address is allocated according to the authorized unique MAC address, and the electronic apparatus 12 may access the mentioned network (or the LAN). Certainly, the electronic apparatus 12 of the embodiment may further comprise a processing unit, a display unit, an input-output unit and/or a battery unit, such that the electronic apparatus 12 is capable of processing different basic operations.

In other embodiments, the non-volatile memory 122 may be a one-time programmable (OTP) memory.

Furthermore, the transmission interface 100 of the embodiment may be a universal serial bus (USB) port or a wireless communication module to be utilized to connect to the connecting module 120 of the electronic apparatus 12. According to different requirements from different users, the electronic apparatus 12 of the embodiment is connected to the network communication apparatus 10 via a wireless communication operation or a wired communication operation, and a transmitted signal between the electronic apparatus 12 and the network communication apparatus 10 may comprise a USB port signal, a power control signal and/or a wireless communication signal. Additionally, if the transmission interface 100 is the USB port, the hub module 102 may be called a USB hub module. In other embodiments, the transmission interface 100 may be a security digital input/output (SDIO) interface, a general purpose input/output (GPIO) interface, a serial peripheral interface (SPI) or another similar wired transmission interface. In other embodiments, the transmission interface 100 may also be a Bluetooth communication interface, a near field communication interface, a Wi-Fi direct communication interface or another similar wireless communication interface.

Under the circumstance that the electronic apparatus 12 is electrically connected to the network communication apparatus 10 via the wireless communication operation or the wired communication operation, the electronic apparatus 12 may transmit the unique MAC address to the storage device SD of the network communication apparatus 10. Accordingly, the unique MAC address may replace the predetermined MAC address, and the network communication apparatus 10 may switch to utilize the unique MAC address to obtain the IP address corresponding to the network (or the LAN), such that the electronic apparatus 12 may utilize the network interface controller 104 of the network communication apparatus 10 to access the related information/data from the network (or the LAN).

In other words, since network managers of the institutions or companies can preset the unique MAC addresses of the electronic device 12 to be authorized by the network (or the LAN), the network communication apparatus 10 may utilize the unique MAC address of the electronic apparatus 12 for connecting to the network (or the LAN) after a user electrically connects the electronic apparatus 12 with the network communication apparatus 10. Regarding the network manager's concerns, since the network manager can identify unique MAC addresses utilized by different electronic apparatuses, it is unnecessary to individually install the software application or preset the operational settings for the electronic apparatuses, such that the efficient monitoring of the network (or the LAN) can be anticipated. In addition, in the prior art, since different electronic apparatuses might share the same MAC address after connecting to the same wired/wireless docking station or dongle system, it may be difficult for the network manager to efficiently manage the network access authorization. In comparison, the embodiment of the present disclosure controls the network communication apparatus 10 to utilize the unique MAC address of one connected electronic apparatus 12, and accordingly, the potential security concern caused by different electronic apparatuses sharing the same MAC address can be significantly prevented in advance.

Moreover, in the present embodiment, if the electronic apparatus 12 is not connected to the transmission interface 100 of the network communication apparatus 10, the network interface controller 104 of the network communication apparatus 10 may switch to utilize the predetermined MAC address for connecting to the network (or the LAN). In other words, the predetermined MAC address of the network communication apparatus 10 will not be rewritten or permanently deleted. Further, according to different types of electronic apparatuses, (i.e., whether the electronic apparatus complies with the operations of the electronic apparatus 12 of the disclosure to have the function as transmitting the unique MAC address to the network communication apparatus 10), the network communication apparatus 10 of the embodiment can be adaptively controlled to utilize the predetermined MAC address or the unique MAC addresses which is successfully authorized, so as to connect to the network (or the LAN).

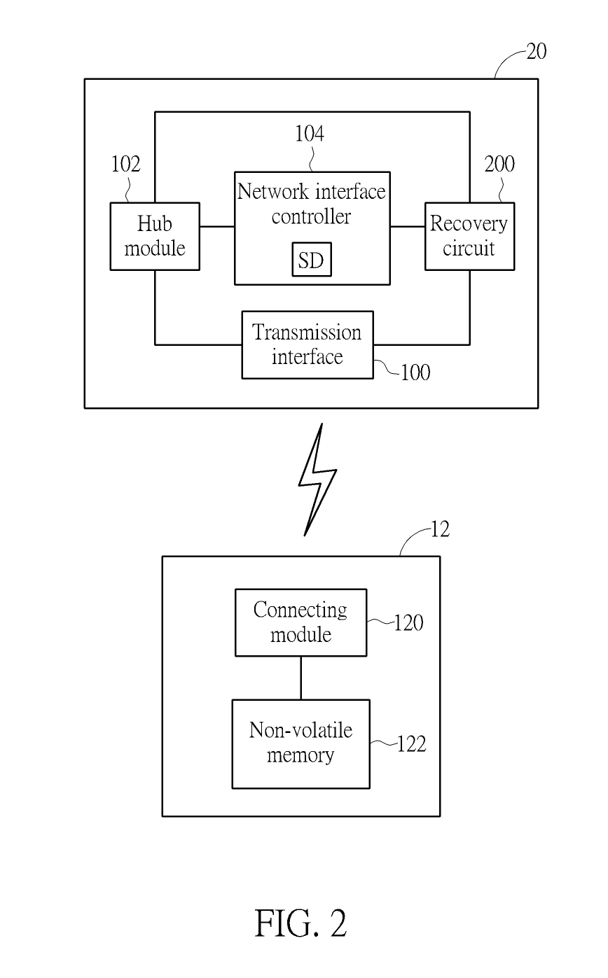

Reference is made to FIG. 2, and FIG. 2 illustrates a schematic diagram of another network communication device 20 coupled to the electronic apparatus 12 according to an embodiment of the disclosure. As shown in FIG. 2, the network communication apparatus 10 further comprises a recovery circuit 200 which integrates a power supply module and is coupled to the transmission interface 100, the hub module 102 and the network interface controller 104 for supplying the power. In one embodiment, if the electronic apparatus 12 is not connected to the transmission interface 100, the recovery circuit 200 further transmits a control command to the network interface controller 104, to make the network interface controller 104 switch to utilize the predetermined MAC address. Certainly, the connection relationship of the recovery circuit 200, the transmission interface 100, the hub module 102 and the network interface controller 104 of the embodiment herein is depicted for demonstration. In some embodiments, those skilled in the art may adaptively add a detection module, a register module and a switch module, in which the detection module is configured to detect the connection relationship between the network communication apparatus 20 and the electronic apparatus 12, the register module is configured to store the unique MAC address of the electronic apparatus 12, and the switch module is configured to switch and output the predetermined MAC address in the storage device SD or the unique MAC address inside the register module, such that the network interface controller 104 can correspondingly utilize the predetermined MAC address or the unique MAC address of the electronic apparatus 12 for connecting to the network (or the LAN).

In other embodiments, the recovery circuit 200 of the disclosure may also be realized by the following operations. For example, a power interruption operation may be processed for the network interface controller 104, an automatic re-initiation operation may be processed for the network interface controller 104, or some similar solutions for realizing the automatic re-initiation operation may be processed for the network interface controller 104 through utilizing a control signal via a GPIO interface, a bus port interface, a wired transmission interface or a wireless transmission interface. Accordingly, if the electronic apparatus 12 is not connected to the transmission interface 100, the mentioned realizations of the recovery circuit 200 are processed to control the network interface controller 104 to utilize the predetermined MAC address for connecting to the network or the LAN.

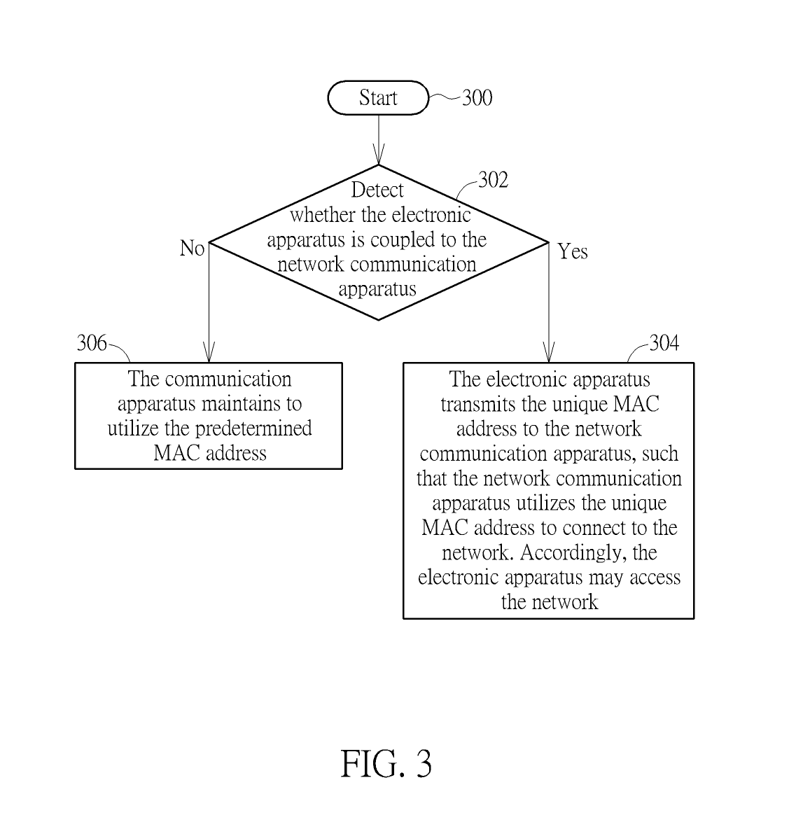

Furthermore, operations between the electronic apparatus and the network communication apparatus of the disclosure may be summarized as a control process 30, which may be compiled into programming codes and separately stored in storage units of the electronic apparatus and the network communication apparatus, and be correspondingly initiated while the connection relationship between the electronic apparatus and the network communication apparatus is formed or disappeared. The control process 30 is shown in FIG. 3 and includes the following steps:
Step 300: Start.
Step 302: Detect whether the electronic apparatus is coupled to the network communication apparatus. If the electronic apparatus is coupled to the network communication apparatus, process step 304; otherwise, process step 306.
Step 304: The electronic apparatus transmits the unique MAC address to the network communication apparatus, such that the network communication apparatus utilizes the unique MAC address to connect to the network. Accordingly, the electronic apparatus may access the network.
Step 306: The communication apparatus maintains to utilize the predetermined MAC address.

In short, the programming codes corresponding to the control process 30 of the disclosure can be separately stored in the storage units of the electronic apparatus and the network communication apparatus. Also, the network communication apparatus of the disclosure may simultaneously connect to different types of electronic apparatuses. Under such circumstance, a plurality of hub modules may cooperate with switching operations of a network interface module, to satisfy the network accessing necessity of the plurality of electronic apparatuses. Alternatively, a network interface module can be operated to directly support/satisfy the network accessing necessity of the plurality of electronic apparatuses. For the electronic apparatus which does not comply with the operation of the electronic apparatus 12 of the disclosure (i.e., not equipping the function as transmitting the unique MAC address to the network communication apparatus 10), the network communication apparatus can utilize the predetermined MAC address to make the electronic apparatus connect to the network (or the LAN). In the meanwhile, for the electronic apparatus which does comply with the operation of the electronic apparatus 12 of the disclosure, the unique MAC address may be correspondingly adopted/utilized for the electronic apparatuses connecting to the network (or the LAN).

To sum up, the embodiments of the disclosure provide a network communication apparatus and an electronic apparatus which can adaptively manage a network access authorization. If the electronic apparatus is electrically connected to the network communication apparatus, the electronic apparatus can transmit the unique MAC address to the network communication apparatus, such that the network interface controller of the network communication apparatus can utilize the unique MAC address to connect to the network or the LAN. If the electronic apparatus is disconnected with the network communication apparatus, the network interface controller can utilize the predetermined MAC address. Accordingly, the network managers of the institutions or companies can adaptively monitor different electronic apparatuses which utilize different unique MAC addresses for simultaneously connecting to the network or the LAN, so as to significantly improve the monitoring capability and to strengthen the network access authorization.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network communication apparatus, comprising:
a transmission interface, configured to couple to an electronic apparatus, wherein the electronic apparatus comprises a non-volatile memory for storing a unique medium access control (MAC) address which is authorized by a network; and
a network interface controller, coupled to the transmission interface and comprising a storage device;
wherein if the electronic apparatus is coupled to the transmission interface, the electronic apparatus transmits the unique MAC address to the storage device, such that the network interface controller utilizes the unique MAC address to connect to the network, and the electronic apparatus is capable of accessing the network.

2. The network communication apparatus of claim 1, wherein the storage device stores a predetermined MAC address, and after the electronic apparatus transmits the unique MAC address to the storage device, the unique MAC address replaces the predetermined MAC address, such that the electronic apparatus accesses the network via the network interface controller.

3. The network communication apparatus of claim 2, wherein if the electronic apparatus is not coupled to the transmission interface, the network interface controller switches to utilize the predetermined MAC address to connect to the network.

4. The network communication apparatus of claim 3, further comprising a recovery circuit coupled to the network interface controller, and if the electronic apparatus is not coupled to the transmission interface, the recovery circuit makes the network interface controller switch to utilize the predetermined MAC address.

5. The network communication apparatus of claim 1, wherein the electronic apparatus is coupled to the network communication apparatus via a wireless communication operation or a wired communication operation, and the transmission interface comprises a wireless communication module or a wired communication module to correspondingly connect to a connecting module of the electronic apparatus.

6. The network communication apparatus of claim 1, further comprising at least one hub module coupled to the transmission interface.

7. An electronic apparatus, configured to couple to a network communication apparatus for accessing a network, the network communication apparatus comprising a transmission interface and a network interface controller, the electronic apparatus comprising:
a non-volatile memory, configured to store a unique medium access control (MAC) address which is authorized by a network; and
a connecting module, configured to connect to the transmission interface;
wherein if the electronic apparatus is coupled to the transmission interface, the electronic apparatus transmits the unique MAC address to a storage device of the network interface controller, such that the electronic apparatus utilizes the network interface controller to connect to the network.

8. The electronic apparatus of claim 7, wherein the storage device stores a predetermined MAC address, and after the electronic apparatus transmits the unique MAC address to the storage device, the unique MAC address replaces the predetermined MAC address, such that the electronic apparatus accesses the network via the network interface controller.

9. The electronic apparatus of claim 8, wherein if the electronic apparatus is not coupled to the transmission interface, the network interface controller switches to utilize the predetermined MAC address to connect to the network.

10. The electronic apparatus of claim 9, wherein the network communication apparatus further comprises a recovery circuit coupled to the network interface controller, and if the electronic apparatus is not coupled to the transmission interface, the recovery circuit makes the network interface controller switch to utilize the predetermined MAC address.

11. The electronic apparatus of claim 7, wherein the electronic apparatus is coupled to the network communication apparatus via a wireless communication operation or a wired communication operation, and the transmission interface comprises a wireless communication module or a wired communication module to correspondingly connect to the connecting module.

12. The electronic apparatus of claim 7, wherein the network communication apparatus further comprises at least one hub module coupled to the transmission interface.
